(19) United States
(12) Patent Application Publication
(10) Pub. No.: US 2017/0177818 A1
(43) Pub. Date: Jun. 22, 2017

(54) Exercise as a Drug

(71) Applicant: Susan Eustis, Lexington, MA (US)

(72) Inventor: Susan Eustis, Lexington, MA (US)

(21) Appl. No.: 15/383,699

(22) Filed: Dec. 19, 2016

Related U.S. Application Data
(60) Provisional application No. 62/269,381, filed on Dec. 18, 2015.

(51) Int. Cl. G06F 19/00

(52) U.S. Cl. CPC G06F 19/3418; G06F 19/322; G06F 19/3481; G06F 19/3456

(57) ABSTRACT

A system and method for monitoring and improving health conditions, by tracking patient compliance and activity levels. A medical device, particularly an oxygen concentrator, supplies a prescribed drug, particularly oxygen, to a user at prescribed time intervals throughout a prescribed exercise routine. An intermediary computing device tracks administration of the prescribed drug and relays the information to a back-end computing device, wherein the back-end computing device determines compliance with a medical prescription. A fitness tracker may optionally be utilized to monitors vitals of the user, wherein vitals data is relayed to the back-end computing device through the intermediary computing device. The back-end computing device can then use the vitals data to generate an adjusted medical prescription.

The current application claims a priority to the U.S. Provisional Patent application Ser. No. 62/269,381 filed on Dec. 18, 2015.

### FIELD OF THE INVENTION

The present invention relates generally to the field of health and wellness. More specifically, the present invention provides a system and method for monitoring and improving health conditions by providing dynamic exercise routines and drug prescriptions according to patient wellness feedback.

### BACKGROUND OF THE INVENTION

Physicians frequently tell their patients to get more exercise and recommend physical therapy in the cases of specific rehabilitation need. Resultantly, sports clubs and sports trainers have become increasingly popular in the US replacing bars as a place for young people to meet in many cases. Many trainers recommend that athletes use oxygen to help game performance or to support exercise at high altitudes. While there are varying circumstances and rules governing use of oxygen in these situations, the use of oxygen by athletes on a bench or at high altitude is expected to increase as small, portable oxygen concentrators become more available.

Oxygen use as a drug is commonly seen in treatment for Chronic Obstructive Pulmonary Disease (COPD), and in some cases the treatment of sleep apnea. However, oxygen as a drug, is available to COPD patients only under prescription. Even though oxygen is purified from the air that everyone breathers, when purified oxygen is used to treat a disease condition, it is available as a drug. So also exercise as a drug is administered after determination of protocols adequate to treat a specific disease or condition. The double blind clinical trials are what characterize a drug.

The evolution of server analytics, cloud computing, smart phones, wearables, and sensor based monitoring systems brings the opportunity for the evolution of exercise as a drug that includes strategic use of new, one to two pound, oxygen concentrator systems. Combination of monitoring diet, and exercise that is supplemented by oxygen use is new, while the collection of information in the context of protocols that have been clinically tested in blind trials, the way any prescription drug is tested, raises the treatment to a new level. The controls provided by electronic monitoring and patient reporting, provide a way to send alerts to physicians and to patients, and represents the evolution of new treatment protocols.

A drug is available for prescription after the exercise of double blind clinical studies. Exercise as a drug is a little different as it depends on clinical trials carefully designed, using supplemental oxygen when indicated. The indications for oxygen need to be determined, they are not known now. In this case, the exercise as a protocol for treating a condition is likely compared to the recognized pharmaceutical drug of choice used for treating the condition. In this manner effective exercise as a drug treatment protocols can be determined. The use of oxygen as a drug in combination with exercise has not been intensively studied to this point.

According to the Food and Drug Administration (FDA), “The broad aim of the process of clinical development of a new drug is to find out whether there is a dose range and schedule at which the drug can be shown to be simultaneously safe and effective, to the extent that the risk-benefit relationship is acceptable”. As we lay out exercise as a drug, it is in this context, there is an attempt to define combined exercise and oxygen delivery protocols that promote healing of specific chronic diseases and enhance health throughout the aging process.

In exercise as a drug, oxygen is used to improve the endurance of the patient and allow increased performance by the patient in line with predefined, well delineated protocols. The commonly used fitness trackers, oxygen concentrators, and cloud based analytics systems come together to provide indication of adherence to a treatment protocol for chronic disease and/or old age. Physicians use the exercise as a drug system to precisely deliver treatment regimens that have been clinically tested. Exercise as a drug is for use in the treatment of specific chronic disease.

Ties to organizations like weight watchers and sports clubs with trainers are anticipated to be a significant part of the exercise as a drug initiative. The ability to collect data on fatigue and supply oxygen to alleviate fatigue and enhance both the exercise experience and the sleep quality are compelling.

### BRIEF DESCRIPTION OF THE DRAWINGS

FIG. 1 is a diagram depicting the medical device and the fitness tracker being communicably coupled to the intermediary computing device, and the intermediary computing device and the physician computing device being communicably coupled to the back-end computing device.

FIG. 2 is a flowchart depicting the steps for monitoring compliance of the medical prescription by reporting the actual dosage of the prescribed drug that is administered at pre-programmed time intervals.

FIG. 3 is a flowchart thereof, further depicting steps for notifying the physician computing device.

FIG. 4 is a flowchart thereof, further depicting steps for reporting compliance with the medical prescription, wherein compliance is determined according to the vitals data.

FIG. 5 is a flowchart thereof, further depicting steps for providing the user with an adjusted medical prescription prior to evaluating the vitals data and the actual dosage administered at each of the pre-programmed time intervals.

### DETAIL DESCRIPTIONS OF THE INVENTION

All illustrations of the drawings are for the purpose of describing selected versions of the present invention and are not intended to limit the scope of the present invention.

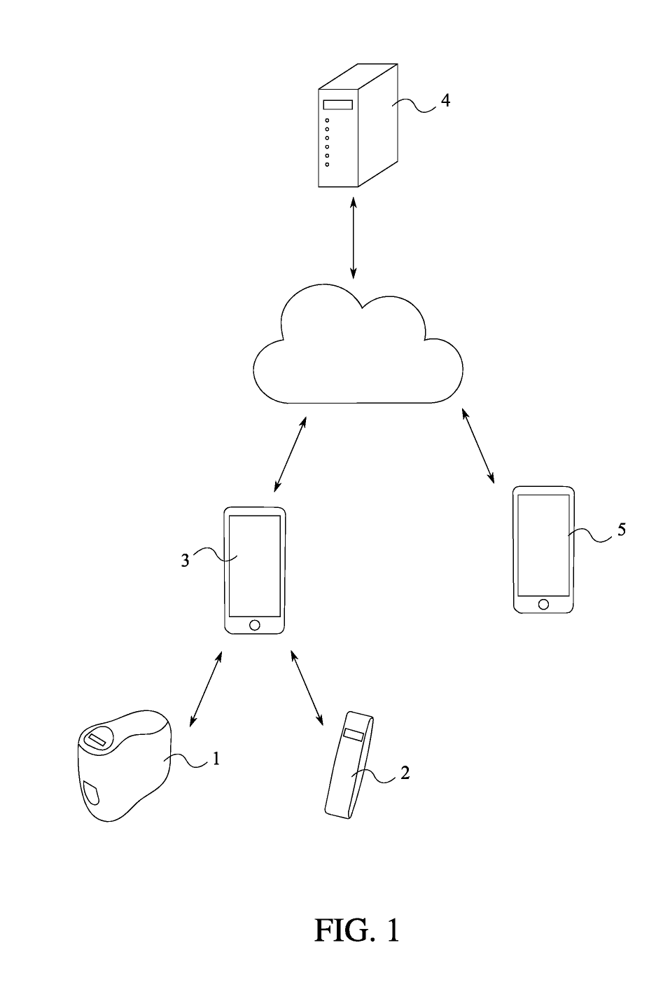

The present invention is a system and method for monitoring and improving health conditions, by tracking patient compliance and activity levels. In reference to FIG. 1, the present invention utilizes a medical device 1, an intermediary computing device 3, a back-end computing device 4, and optionally, a fitness tracker 2. The intermediary computing device 3 and the back-end computing device 4 are utilized in conjunction with the medical device 1 to track patient compliance, and generate personalized exercise plans when used in conjunction with the fitness tracker 2. The medical device 1 is hereinafter described as being an oxygen concentrator, however, it is to be known that the medical device 1 may be any other medical assistance device used to treat various health conditions.

The intermediary computing device 3 is a personal device of a user, such as a smartphone, tablet, laptop, etc. In reference to FIG. 1, the medical device 1 is communicably coupled to the intermediary computing device 3 through either a wired connection or a wireless connection. Meanwhile, the intermediary computing device 3 is communicably coupled to the back-end computing device 4 across a wide area network, or alternatively a local area network. The back-end computing device 4 can be a singular server, multiple servers, or any similar device. Data is gathered by the intermediary computing device 3, from the medical device 1, and relayed to the back-end computing device 4, wherein the data is accessible to selected medical personnel for tracking compliance of the user with regards to a drug prescription.

The fitness tracker 2 is utilized to monitor vitals of the user in order to track the fitness and activity levels of the user. The fitness tracker 2 may include various sensors and software, including but not limited to, a pulse oximeter to measure oxygen levels, blood sugar monitoring devices to measure glucose levels, blood pressure measuring sensors to determine blood pressure reading or changes in blood pressure, heart rate sensors, electrocardiogram (EKG) monitoring sensors, exercise and sleep numeric measurements based on movement, movement sensors to determine level of exercise, and fatigue calculating software. Similar to the medical device 1, the fitness tracker 2 is communicably coupled to the intermediary computing device 3, either through a wired connection or a wireless connection as depicted in FIG. 1. Data is gathered by the intermediary computing device 3, from the fitness tracker 2, and relayed to the back-end computing device 4, wherein the data from the fitness tracker 2 and the data from the medical device 1 is analyzed by the back-end computing system to provide clinical treatment regimens specific to the user.

The tracking of the data from the medical device 1 and the fitness tracker 2 can be used to further improve chronic conditions and overall health of the user. Tracking can be used to provide further insight into the prescribed treatment protocols, by using analytics to gage the relative effectiveness of different clinical treatment regimens; the clinical treatment regimens including different exercise routines and different administration levels of oxygen. The exercise routines can be as mild as walking around the home, or more extreme, such as vigorous lengthy workouts. The supplemental oxygen serves to prolong the exercise routines, thus improving health of the user through physical motion. The supplemental oxygen is acting to repair the body of the user in the same fashion as a drug would function, while the exercise further improves the physical wellbeing of the user.

The present invention captures movement information during exercise or sleep through the fitness tracker 2, and combines that information with software analytics that have been clinically tested to provide specific treatments. One aspect of the present invention is to get the brain working better. This is accomplished through adherence to clinical treatment regimens that are specifically generated for the user; the clinical treatment regimens being consistent with clinically tested protocols. Exercises may vary between individuals, even when treating the same health condition, as each individual's body reacts differently, and thus the need for the fitness tracker 2 to provide individual body metrics.

The present invention can be used to generate dynamic exercise protocols for treating particular disease or health conditions such as diabetes, elevated blood pressure, heart failure, depression, dementia, obesity, the naturally occurring condition of old age, etc. The present invention is the evolution of well-designed protocols targeted to particular human conditions that need to be treated. General guidelines can be constructed for treating a particular condition, however, patient data is needed in order to maximize the effectiveness of the treatment. Thus, the way that exercise becomes a drug is when oxygen is used in combination with monitors to control the timing and dispensing quantities of the oxygen from the medical device 1.

In order to monitor patient compliance in the treatment of a health condition, the user will first receive a medical prescription from a physician or other medical personnel; the medical prescription including a prescribed exercise routine, a prescribed dosage of a prescribed drug, and prescribed time intervals for administering the prescribed drug. In the preferred embodiment of the present invention, the prescribed drug is oxygen. The prescribed exercise routine instructs the user on the physical activities that are to be carried out and monitored. Meanwhile, the prescribed dosage and the prescribed time intervals are intended to be programmed into the medical device 1. The prescribed dosage and the prescribed time intervals may be manually entered into the medical device 1, or downloaded onto the medical device 1 via the intermediary computing device 3.

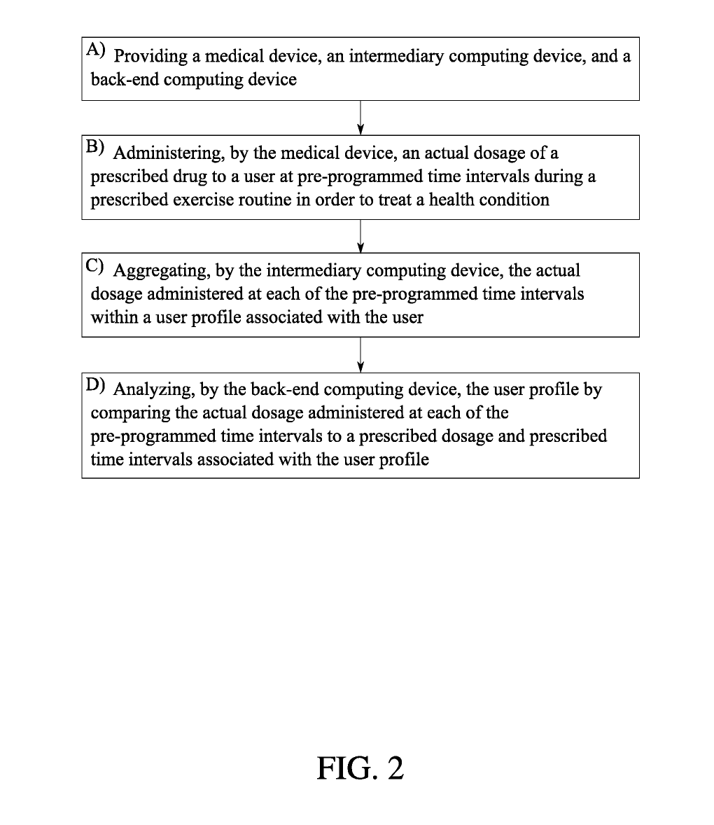

In reference to FIG. 2, the medical device 1 is then used to administer an actual dosage of the prescribed drug to the user at pre-programmed time intervals throughout the duration of the prescribed exercise routine in order to treat the health condition. Meanwhile, the intermediary computing device 3 aggregates the actual dosage administered at each of the pre-programmed time intervals within a user profile for the user. In the preferred embodiment of the present invention, the information is aggregated through a downloadable application through which the user logs into the user profile; in this way, when logged into the user account, the gathered information is associated directly with the user. The user profile is then synchronized with the back-end computing device 4 by the intermediary computing device 3.

In further reference to FIG. 2, the back-end computing device 4 then analyzes the user profile by comparing the actual dosage administered at each of the pre-programmed time intervals to the prescribed dosage and the prescribed time intervals associated with the user profile. In this way, the compliance of the user in adhering to the medical prescription can be tracked. Non-compliance with the medical prescription, whether intentional or not, can be relayed to the physician or designated medical personnel. For example, the user may accidentally enter a wrong value when manually programming the medical device 1, such that the actual dosage or the pre-programmed intervals do not match the prescribed dosage or the prescribed time intervals respectively.

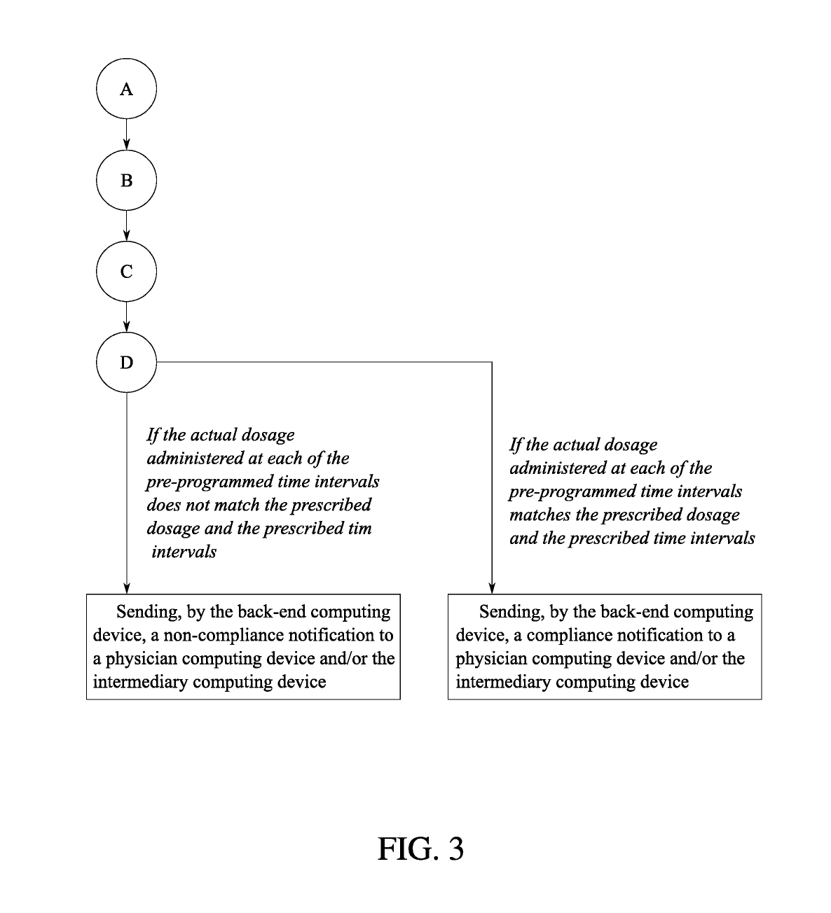

In reference to FIG. 3, if the actual dosage administered at each of the pre-programmed time intervals does not match the prescribed dosage and the prescribed time intervals, then the back-end computing device 4 sends a non-compliance notification to a physician computing device 5 and/or the intermediary computing device 3. In this way, the non-compliance notification can be logged in medical files for the user. The physician computing device 5 can be any computer system communicably coupled to the back-end computing device 4. On the other hand, if the actual dosage administered at each of the pre-programmed time intervals matches the prescribed dosage and the prescribed time intervals, then the back-end computing device 4 sends a compliance notification to the physician computing device 5 and/or the intermediary computing device 3. In this way, the compliance notification can be logged in the medical files of the user.

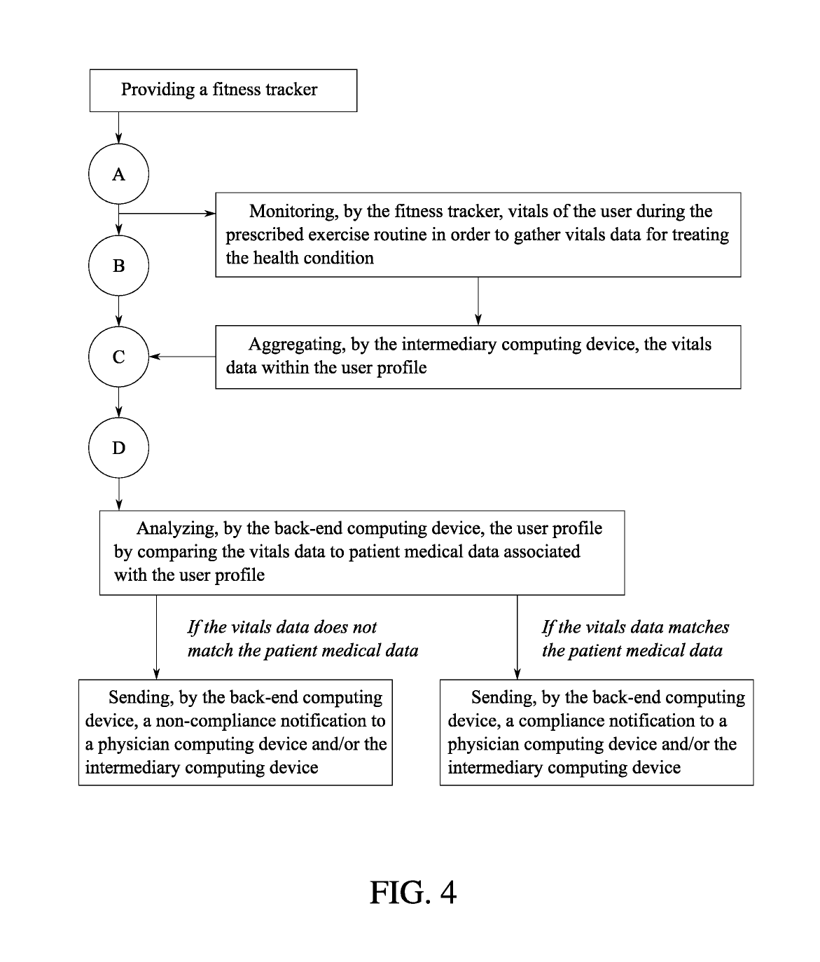

In order to generate dynamic exercise protocols, the fitness tracker 2 is used in conjunction with the functions of the medical device 1 as described above. In reference to FIG. 4, the fitness tracker 2 monitors vitals of the user during the prescribed exercise routine in order to gather vitals data for treating the health condition. The fitness tracker 2 continuously monitors the vitals of the user, while the medical device 1 administers the actual dosage of the prescribed drug at the pre-programmed time intervals. The intermediary computing device 3 aggregates the vitals data within the user profile, along with the actual dosage administered at each of the pre-programmed time intervals. The user profile is then synchronized with the back-end computing device 4 by the intermediary computing device 3.

The back-end computing device 4 then analyzes the user profile in two ways: by comparing the actual dosage administered at each of the pre-programmed time intervals to the prescribed dosage and the prescribed time intervals; and by comparing the vitals data to patient medical data associated with the user profile. The patient medical data may include a height, a weight, an age, normal vitals, or any other information on parameters of the user that may be pertinent to treating the health condition. Through analyzing the user profile, the back-end computer is able to generate an adjusted medical prescription according to the vitals data, in addition to monitoring the compliance of the user in adhering to the medical prescription.

In addition to determining compliance of the medical prescription using the actual dosage administered at the pre-programmed time intervals, the vitals data can be utilized to determine compliance. In reference to FIG. 4, if the vitals data does not match the patient medical data, then the back-end computing device 4 sends a non-compliance notification to the physician computing device 5 and/or the intermediary computing device 3. In this way, the non-compliance notification derived from the vitals data can be logged in medical files for the user. On the other hand, if the vitals data matches the patient medical data, then the back-end computing device 4 sends a compliance notification to the physician computing device 5 and/or the intermediary computing device 3. In this way, the compliance notification derived from the vitals data can be logged in the medical files of the user.

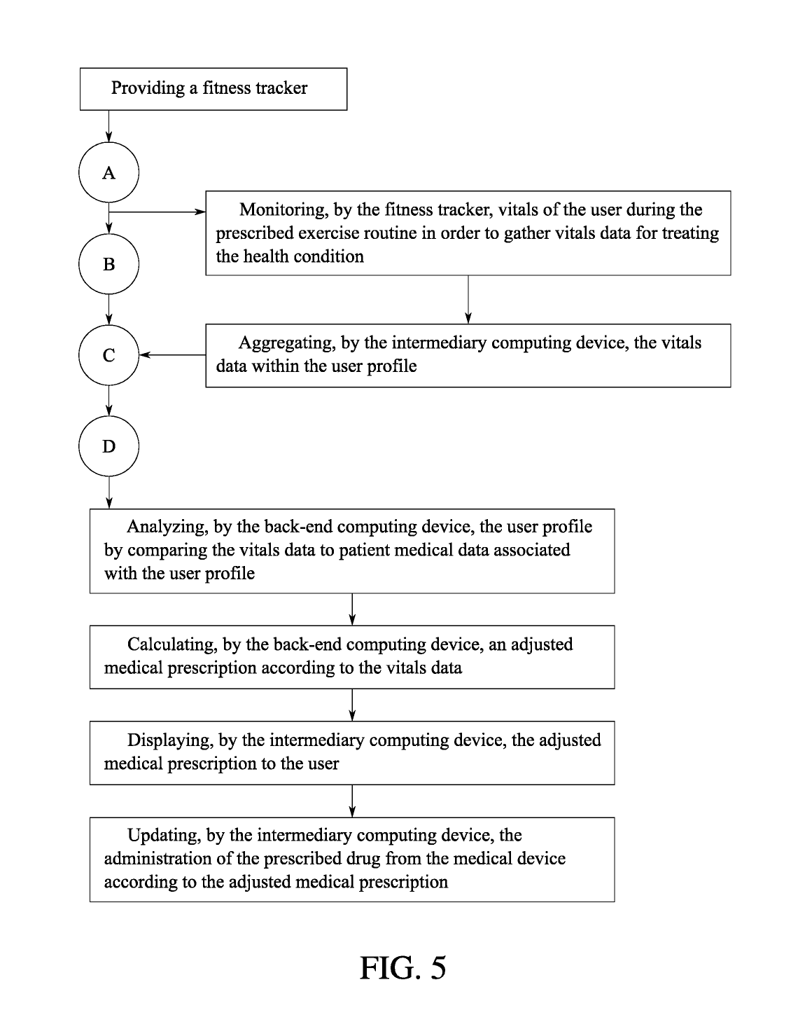

The adjusted medical prescription is an update to the medical prescription originally presented by the physician or medical personnel. In reference to FIG. 5, the back-end computing device 4 calculates the adjusted medical prescription according to the vitals data, wherein vitals data may be compared to the patient medical data, the medical prescription, clinically tested protocols for treating the health condition, or any other information necessary in evaluating the performance of the prescribed exercise routine by the user. The adjustments made to the medical prescription in order to form the adjusted medical prescription may include updating the prescribed exercise routine, changing the prescribed dosage of the prescribed drug, or changing the prescribed time intervals for administering the prescribed drug.

The way in which, and the extent to which, the medical prescription is updated depends on the compliance of the patient with the medical prescription. For example, the user may be compliant with the medical prescription over a period of time, and thus the prescribed dosage or the prescribed time intervals may be decreased due to the user getting stronger. Or the prescribed exercise routine may be adjusted by adding exercises or increasing the length of exercises, to make the prescribed exercise routine harder for the user. Non-compliance of the medical prescription might indicate that the user is struggling with the prescribed exercise routine, and therefore exercises may be shortened or removed. Alternatively, the prescribed dosage or the prescribed time intervals can be increased to enhance the ability of the user to perform the prescribed exercise routine.

In reference to FIG. 5, once the back-end computing device 4 has calculated the adjusted medical prescription, the back-end computing device 4 sends the adjusted medical prescription to the intermediary computing device 3. The intermediary computing device 3 can then display the adjusted medical prescription to the user, such that the user is able to comply with the adjusted medical prescription. Furthermore, the intermediary computing device 3 updates the administration of the prescribed drug from the medical device 1 according to the adjusted medical prescription. More specifically, the intermediary computing device 3 updates either the prescribed dosage and/or the prescribed time intervals according to the adjusted medical prescription.

Although the invention has been explained in relation to its preferred embodiment, it is to be understood that many other possible modifications and variations can be made without departing from the spirit and scope of the invention as hereinafter claimed.

What is claimed is:

1. A method for monitoring and improving health conditions, the method comprises the steps of:
providing a medical device, an intermediary computing device, and a back-end computing device;
administering, by the medical device, an actual dosage of a prescribed drug to a user at pre-programmed time intervals during a prescribed exercise routine in order to treat a health condition;
aggregating, by the intermediary computing device, the actual dosage administered at each of the pre-programmed time intervals within a user profile associated with the user; and
analyzing, by the back-end computing device, the user profile by comparing the actual dosage administered at each of the pre-programmed time intervals to a prescribed dosage and prescribed time intervals associated with the user profile.

2. The method for monitoring and improving health conditions, the method as claimed in claim 1 further comprises the steps of:
providing a fitness tracker;
monitoring, by the fitness tracker, vitals of the user during the prescribed exercise routine in order to gather vitals data for treating the health condition;
aggregating, by the intermediary computing device, the vitals data within the user profile; and
analyzing, by the back-end computing device, the user profile by comparing the vitals data to patient medical data associated with the user profile.

3. The method for monitoring and improving health conditions, the method as claimed in claim 2 further comprises the step of:
calculating, by the back-end computing device, an adjusted medical prescription according to the vitals data.

4. The method for monitoring and improving health conditions, the method as claimed in claim 3 further comprises the step of:
displaying, by the intermediary computing device, the adjusted medical prescription to the user.

5. The method for monitoring and improving health conditions, the method as claimed in claim 3 further comprises the step of:
updating, by the intermediary computing device, the administration of the prescribed drug from the medical device according to the adjusted medical prescription.

6. The method for monitoring and improving health conditions, the method as claimed in claim 3, wherein calculating the adjusted medical prescription includes updating the prescribed exercise routine.

7. The method for monitoring and improving health conditions, the method as claimed in claim 3, wherein calculating the adjusted medical prescription includes changing the prescribed dosage of the prescribed drug.

8. The method for monitoring and improving health conditions, the method as claimed in claim 3, wherein calculating the adjusted medical prescription includes changing the prescribed time intervals for administering the prescribed drug.

9. The method for monitoring and improving health conditions, the method as claimed in claim 2, wherein the fitness tracker monitors oxygen levels.

10. The method for monitoring and improving health conditions, the method as claimed in claim 2 further comprises the step of:
sending, by the back-end computing device, a non-compliance notification to a physician computing device, if the vitals data does not match the patient medical data.

11. The method for monitoring and improving health conditions, the method as claimed in claim 2 further comprises the step of:
sending, by the back-end computing device, a compliance notification to a physician computing device, if the vitals data matches the patient medical data.

12. The method for monitoring and improving health conditions, the method as claimed in claim 2 further comprises the step of:
sending, by the back-end computing device, a non-compliance notification to the intermediary computing device, if the vitals data does not match the patient medical data.

13. The method for monitoring and improving health conditions, the method as claimed in claim 2 further comprises the step of:
sending, by the back-end computing device, a compliance notification to the intermediary computing device, if the vitals data matches the patient medical data.

14. The method for monitoring and improving health conditions, the method as claimed in claim 1, wherein the medical device is an oxygen concentrator.

15. The method for monitoring and improving health conditions, the method as claimed in claim 1, wherein the prescribed drug is oxygen.

16. The method for monitoring and improving health conditions, the method as claimed in claim 1 further comprises the step of:
sending, by the back-end computing device, a non-compliance notification to a physician computing device, if the actual dosage administered at each of the pre-programmed time intervals does not match the prescribed dosage and the prescribed time intervals.

17. The method for monitoring and improving health conditions, the method as claimed in claim 1 further comprises the step of:
sending, by the back-end computing device, a compliance notification to a physician computing device, if the actual dosage administered at each of the pre-programmed time intervals matches the prescribed dosage and the prescribed time intervals.

18. The method for monitoring and improving health conditions, the method as claimed in claim 1 further comprises the step of:
sending, by the back-end computing device, a non-compliance notification to the intermediary computing device, if the actual dosage administered at each of the pre-programmed time intervals does not match the prescribed dosage and the prescribed time intervals.

19. The method for monitoring and improving health conditions, the method as claimed in claim 1 further comprises the step of:
sending, by the back-end computing device, a compliance notification to the intermediary computing device, if the actual dosage administered at each of the pre-programmed time intervals matches the prescribed dosage and the prescribed time intervals.
